(19) United States
(12) Patent Application Publication
(10) Pub. No.: US 2024/0245970 A1
(43) Pub. Date: Jul. 25, 2024

(54) AUTOMATED SCORE AWARDING SYSTEM FOR COMBAT SPORTS

(71) Applicant: RESEARCH INDUSTRIAL SYSTEMS ENGINEERING (RISE) FORSCHUNGS-, ENTWICKLUNGS-UND GROßPROJEKTBERATUNG, Schwechat (AT)

(72) Inventors: Dominik HÖLBLING, Münchendorf (AT); Christoph LICHTMANNEGGER, Eugendorf (AT); Roland BREITENEDER, Buchkirchen (AT)

(21) Appl. No.: 18/291,876

(22) PCT Filed: Jun. 29, 2022
(86) PCT No.: PCT/AT2022/060228

§ 371 Date: Jan. 24, 2024

(30) Foreign Application Priority Data
Jul. 26, 2021 (AT) A 50619/2021

(51) Int. Cl. A63B 71/06; A63B 24/00; A63B 71/14

(52) U.S. Cl. CPC A63B 71/0605; A63B 24/0003; A63B 24/0062; A63B 71/145; A63B 2220/30; A63B 2220/53; A63B 2220/807; A63B 2220/836

(57) ABSTRACT

The invention relates to a system for automated score awarding in combat sports, comprising: at least one punching glove for measuring punch force data developing during a punch; at least one camera, preferably at least four cameras, for capturing images of at least one athlete; a body segment recognition module connected to the camera(s) for determining body segment data of the athlete from the images captured by the cameras; a rule set module, in which at least one rule set of a predetermined combat sport is stored; an evaluation unit, which is connected to the punching glove, to the body segment recognition module and to the rule set module; wherein the evaluation unit is configured to output a score fully automatically at an output when both the punch force measured by the punching glove and the body segment data determined by the body segment recognition module result in a score according to the rule set.

The invention relates to an automated score awarding system for combat sports.

In combat sports, usually two or more athletes compete against each other in a ring and attempt to land hits on each other through punches, kicks, or other physical contact. The winner of such fights is typically determined by a scoring system, wherein, for example, a successful punch results in a score of one or more points (or a fraction thereof) being awarded. The athlete, who has reached more points after a predetermined time or who has exceeded a certain point threshold, emerges as the winner of the fight. Examples of such combat sports that are the subject of this specification include boxing, karate, kickboxing, taekwondo, kung fu, etc.

It is common to provide a referee or a panel of referees for each fight. The referee(s) observe(s) the fight and award(s) scores when they recognize that an action, such as a hit, by an athlete deserves a score. As is generally known, however, score awarding by referees is highly subjective and will often trigger discussions.

In order to facilitate the work of the referees, it has in particular been known from prior art to record videos and statistical data and make them available. As example, there may be mentioned US 2017/134712, US 2018/001141, US 2012/144414, and WO 2019/106672. From these documents, it is known to collect and provide various statistical data, obtained through cameras or 3D cameras, respectively, on one hand, and sensors carried by the athletes, such as smart combat gloves, on the other hand. However, all these disclosures only support the referee when awarding scores.

WO 2020/041806 also discloses a combat glove for determining the quality of a punch. For this purpose, acceleration data measured during a punch is combined with force data.

Unlike the disclosures mentioned above, however, it is not the task of the invention to provide statistical data, but rather to create an automated score awarding system. An obvious solution to this task is not given, though, in view of the disclosures above, as, rather conversely, the large amount of data provided actually makes efficient score awarding more difficult. It is thus the task of the invention to provide a system for automated score awarding in combat sports, wherein score awarding is to be carried out as efficiently and accurately as possible.

This task is solved by a system for automated score awarding in combat sports, comprising
at least one punching glove for measuring punch force data developing during a punch;
at least one camera, preferably at least four cameras, for capturing images of at least one athlete;
a body segment recognition module connected to the camera(s) for determining body segment data of the athlete from the images captured by the cameras;
a rule set module, in which at least one rule set of a predetermined combat sport is stored, wherein the rule set provides a score for a punch with a predetermined minimum punch force at a predetermined position of body segment data;
an evaluation unit, which is connected to the punching glove for receiving the punch force data, which is connected to the body segment recognition module for receiving the body segment data and which is connected to the rule set module for receiving the at least one rule set:
   wherein the evaluation unit is configured to output a score fully automatically at an output when both the punch force measured by the punching glove and the body segment data determined by the body segment recognition module result in a score according to the rule set.

According to the invention, automated score awarding is achieved by linking punch force data recorded by the punch glove with body segment data captured by the cameras. The inventors have found that these data are in general sufficient to detect a hit with great accuracy and thereby enable the awarding of scores. This is based on the fact that the it is possible by using body segment data to precisely determine how an athlete is positioned, especially in relation to their opponent, making it possible to determine exactly whether, where, and how a punch has resulted in a hit, for example, right hand hitting the head. Similarly, it is possible by using the punch force data to determine whether the force of the punch is sufficient for awarding scores or whether only a light touch has occurred. Similarly, there is to be noted that a hit cannot be accurately determined if only one of the two sets of measurement data is available, as the athlete could decelerate their hand just before impact, which should not result in a score but cannot be determined solely by body segment data. Similarly, it cannot be determined solely by punch force measurement data whether, for example, a hit is on the opponent's body or on prohibited regions.

Score awarding may thus be carried out based on these two sets of measurements and a pre-stored rule set, thereby not only supporting the referees but also fully replacing them in definite and obvious cases of score awarding. Since the measurement data is compared with the stored rules, evaluation is carried out very efficiently, well-defined, and comprehensible. The accuracy of the system is determined by the choice of measurement data, as punch force is much more meaningful for these purposes than measured acceleration, while the novel determination of body segment data for this purpose significantly simplifies the determination of the type of hits.

Furthermore, the invention enables the collection of statistical data about referees, which may then be transferred to an e-learning system and in combination with the rules and regulations may result in a comprehensive assessment.

In a preferred embodiment, the system further comprises a scoring counter system, which is connected to the evaluation unit for receiving the scores output by the evaluation unit, and a video verification system connected to the cameras, wherein the video verification system is configured to output the images captured by the cameras of a period of time to be verified, and a score of the scoring counter system may be updated or corrected after verification on the video verification system. In this way, it is possible for errors in the system to be rectified. For example, this may be realized if a trainer of an athlete raises a manual objection and requests a check on the video verification system. In this case, the video verification system may present a video to a referee for independent checking such that this may manually award a scoring.

The embodiment mentioned above may also be semi-automated by requiring a manual verification of a fight sequence by the system according to the invention if the evaluation is not definite and obvious. For implementation thereof, the video verification system is connected to the evaluation unit, and the evaluation unit is configured to output a signal to verify an action of the athlete to the video verification system if only a predetermined punch force or only a predetermined position of body segment data according to the rule set of the predetermined combat sport is present.

The definition of the rule sets may be carried out by a person skilled in the art. For example, a rule set may provide one point for a body punch, two points for a body kick, and two points for a head punch.

Furthermore, the system according to the invention may also be used for various combat sports. For this purpose, at least two rule sets from respectively different combat sports are stored in the rule set module, and the rule set module has an interface for selecting the rule set to be used by the evaluation unit. It may thus be easily selected for which combat sport the system is used by making a selection on the rule set module. In this way, there is prevented that the system has to be completely replaced if the athletes switch the type of combat sports.

The body segment recognition module mentioned above may preferably be configured, for the determination of the body segments, to recognize anatomical points, preferably joint points, on an athlete recognized in the images and to connect them to segments, i.e., by means of segments, preferably at least ten, fifteen, or twenty segments. In particular, at least one segment for the head, at least one segment for the torso, and at least one segment for each upper arm, forearm, femur, and shank may be used. These segments are particularly relevant for determining the type of hits in combat sports. Additionally, separate body segments for the front, back, and side of the body, e.g., torsos or heads, may be for differentiation, as in some sports, hits to the front or side of the torso are allowed, but not to the back. Moreover, segments for the pelvis, neck, hands, and feet may also be relevant. It will be appreciated that the orientation of the segments, e.g., their spatial position, is also recognized during the recognition of the segments.

Depending on the camera system or the downstream image evaluation, respectively, the body segments may be analysed differently. However, it is particularly preferred if the body segment data determined by the body segment recognition module comprises 3D trajectories of recognized body segments. In this way it is made possible, for example, that the accurate trajectory of a forearm segment be tracked, thereby enabling an even more accurate determination of a hit or a blocking position. If necessary, the arrangement of the cameras relative to each other in space may be pre-stored in the body segment recognition module to more accurately determine the 3D trajectories.

In the simplest embodiment, the awarding of scores may be carried out by evaluating only the punch force and the body segment data by way of the rule set module to determine whether a score may be awarded, i.e., no further measurement data will be used at all. However, in other embodiments, additional measurement data, including raw measurement data, may be taken into account. In a particularly preferred embodiment, a technique recognition module is used, which determines a technique of the athlete(s) in order to simplify evaluation. For this purpose, the punch glove is further configured to record speed data and/or acceleration data, wherein the system further comprises a technique recognition module, which is connected to the punch glove for receiving the speed data and/or acceleration data and which is connected to the body segment recognition module for receiving the body segment data, wherein the technique recognition module is configured to recognize a technique of the athlete from the body segment data in conjunction with the speed data and/or acceleration data, wherein the evaluation unit is connected to the technique recognition module and takes the recognized technique into account when awarding scores. In particular, the recognized technique may include a striking technique determined by the speed data and/or acceleration data and/or an overall movement technique recognized by the body segment data.

Furthermore, the system preferably comprises a machine learning module, which is connected to the evaluation unit, the punch glove, the body segment recognition module and/or optionally the technique recognition module, wherein the machine learning module comprises an interface for receiving feedback regarding a score and/or a technique and is configured to adapt an evaluation logic of the evaluation unit and/or optionally the technique recognition module or to generate a new rule set for the rule set module. In this way, the accuracy of the system may be further improved, as the system may better assess possible scores that are limit situations in the rule set module or may assess situations that are not inherently stored in the rule set module. The machine learning module may be used to systematically improve and evaluate the data collection of all individual partial component (if there is used, for example, Vicon Motion Capturing System, there may be evaluated a system, e.g. the body segment recognition, and using this result improved all other systems).

Even though the system mentioned above is primarily used as a score awarding system, it may also be used secondarily to determine combat statistics or the like. In particular, the evaluation unit may be configured to output combat statistics, the technique recognition module to output technique statistics, the punch glove to output technique intensity data, the body segment recognition module to output technique animation and/or kinematic analysis data, and the cameras to output visual data.

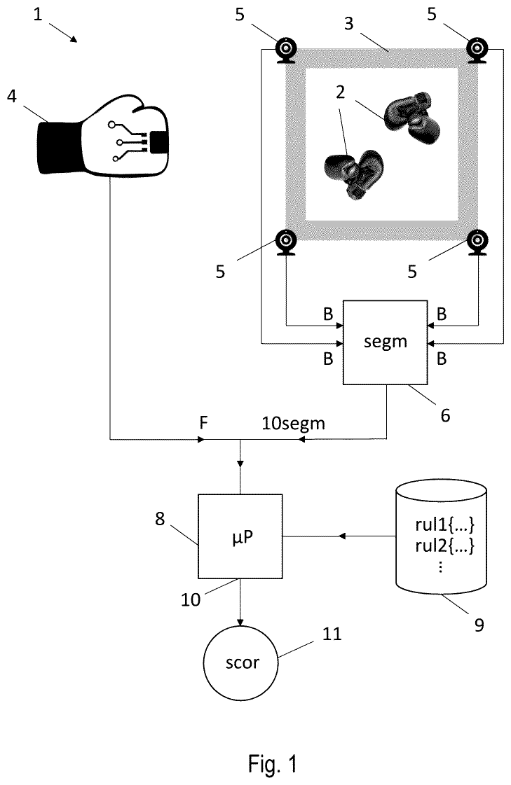

FIG. 1 shows a system according to the invention for automated score awarding.

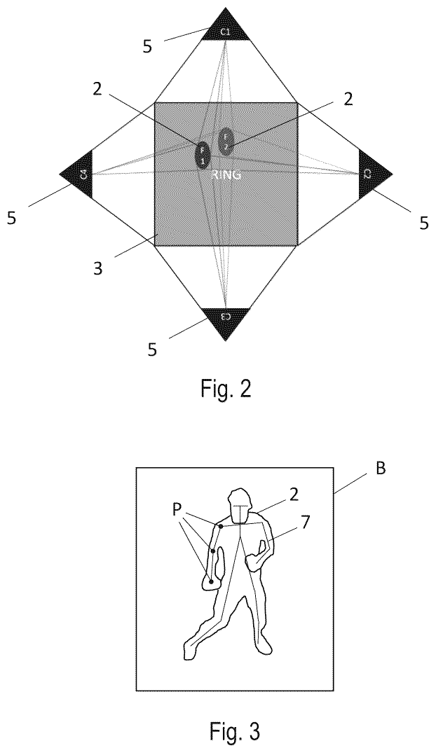

FIG. 2 shows a top view of a ring with four cameras.

FIG. 3 schematically shows an image captured by the cameras, wherein body segments of an athlete have been added.

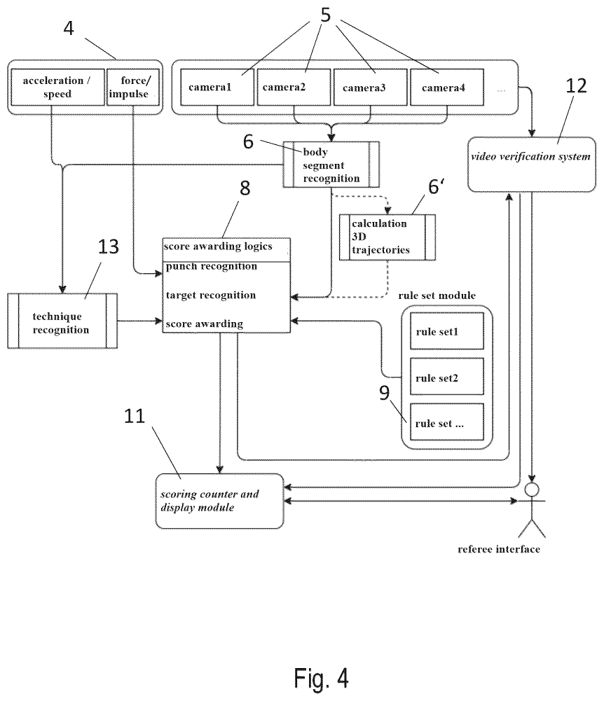

FIG. 4 shows a first embodiment variant of the system according to the invention.

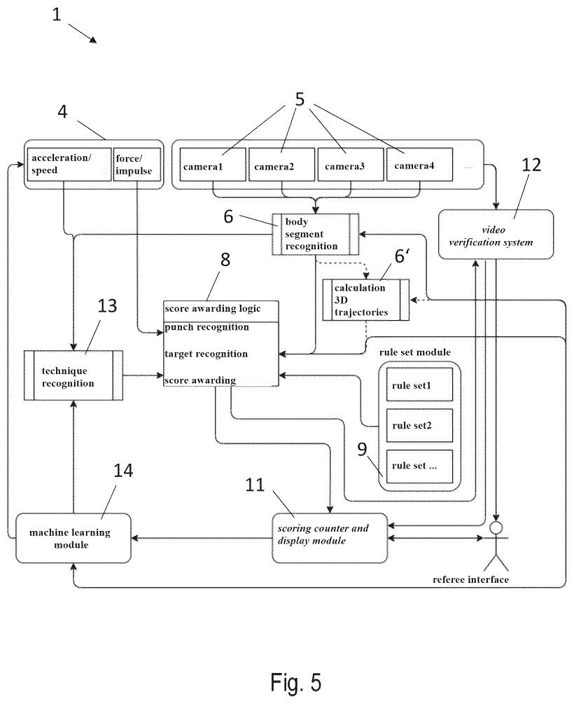

FIG. 5 shows a second embodiment variant of the system according to the invention.

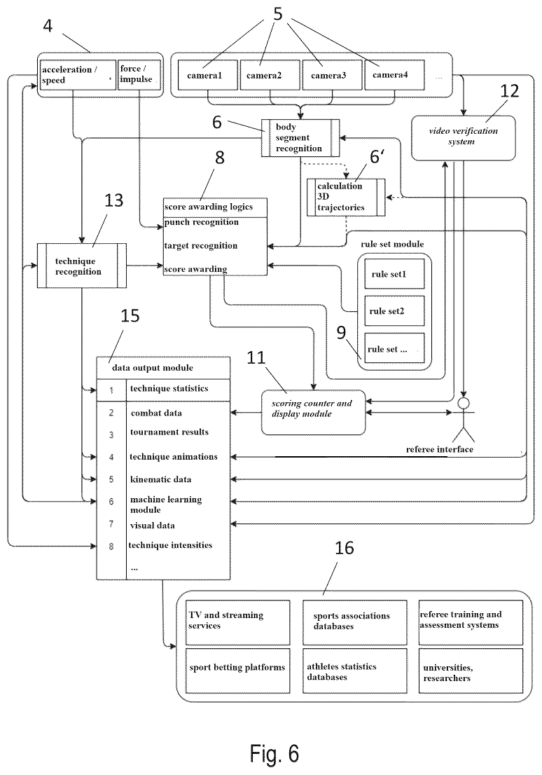

FIG. 6 shows a third embodiment variant of the system according to the invention.

FIG. 1 depicts a system 1 for automated score awarding in combat sports, for example, to replace a referee. In these combat sports, e.g., boxing, kickboxing, karate, etc., in general two athletes 2 compete in a ring 3, for example, a combat arena. In FIG. 1, the two athletes 2 in the ring 3 are schematically represented by respectively two boxing gloves. However, the invention is not limited to awarding scores with two athletes 2 but could rather also be used with a single athlete 2, e.g., for training evaluation, or with more than two athletes 2, e.g., for 2v2 fights.

The system 1 may be used, however, not only directly in a fight as a complete referee replacement but also for assessing the performance of referees in parallel operation, as an additional digital referee in parallel operation, as support for video verifications, as a replacement for a single referee, or as a replacement for external referees down to an intervention referee. The system 1 could also be used as a training system to provide feedback to the athletes 2 on the execution of the combat sport, for example, by means of an e-learning component.

In order to enable automated score awarding, at least one of the athletes 2 wears at least one punch glove 4, which is schematically shown in the upper left of FIG. 1. Typically, each athlete 2 wears one of these punch gloves 4 on each hand, optionally two more on each foot, wherein the punch glove 4 here may be adjusted to the anatomical shape of the foot. The punch gloves 4 may also be worn only on the feet. It is thus evident that the terms “punch” and “kick” are used synonymously herein and generally refer to a “hit.” Furthermore, such punch gloves 4 may be worn as guards with sensors on the shins, elbows, head, or torso. The punch glove 4 differs from regular punch gloves 4 in that it comprises sensors for measuring punch force data during a punch. Optionally, the punch glove 4 may also record acceleration measurement data for the purposes of the technique recognition module 13, as explained below: The punch glove may be implemented as disclosed in WO 2020/041806, for example.

Furthermore, for automated awarding of scores, there is provided at least one camera 5, e.g., a 3D camera, at the ring 3, wherein the ring 3 is situation with the field of view of the camera 5. Preferably, there are provided at least four, more preferably exactly four, cameras 5, which capture the ring 3 from different directions, as depicted in FIG. 2. This allows for reducing the risk that relevant actions be obscured by the bodies of the athletes 2. The cameras 5 typically capture images B at a predetermined frame rate to record videos. The images B or videos may be used not only for the present system 1 but also for general recording or transmission, respectively, such as a TV broadcast or a live stream.

Returning to FIG. 1, it can be seen that the cameras 5 are connected to a body segment recognition module 6 for determining body segment data 7 (FIG. 3) of the athlete 2, for example, by wired or wireless means, e.g., via Bluetooth. The body segment data 7 serves to describe or represent the athletes 2 recognized in the images B in an easily processable manner. For this purpose, anatomical points P, such as joint points of the athlete 2, are typically recognized in the image B and connected by segments, i.e., straight lines, which subsequently represent the body segment data 7. The body segment recognition module 6 may be pre-set to determine which and how many, respectively, body segments should be determined. This may also depend on the specific combat sport, as the wrist position may be relevant for score awarding in a combat sport, and therefore two additional body segments of the athlete 2 may be determined, while this may be irrelevant for the awarding of scores in other combat sports, and therefore the additional determination of these body segments may be omitted. However, there is in general provided that at least 10 body segment data 7 are to be determined.

FIG. 3 schematically shows how the body segment data 7 may be determined in an image B. First, there may recognized an athlete 2 in the image B. Then, anatomical points P of the athlete 2 may be determined and connected by the body segment data 7. Typically, at least body segment data 7 for both shanks, both femurs, both forearms, both upper arms, the head, and the torso are determined. In the example shown in FIG. 3, the body segment data 7 of the torso comprise a shoulder width, a vertical neck or torso line, and two hip lines. It is appreciated, however, that the body segment data 7 may also be chosen differently.

Determining body segment data 7 in general is generally known from software implementations in other technical fields, so this will not be further detailed here. The specific implementation of the body segment recognition module 6 may therefore be left to the person skilled in the art. Typically, an outline of the athlete 2 in the image B is first determined, from which the anatomical points P are then calculated and, in turn, the body segment data 7. In order to make the process more efficient for sequential images B of a video, body or body segment tracking software may additionally be used.

It can also be seen from FIG. 1 that the body segment recognition module 6 may be connected to several cameras 5. Since the cameras 5 provide images B taken at the same time, the body segment recognition module 6 determines only one set of body segment data from the plurality of images B of the same point of time, i.e., the body segment recognition module 6 links those images B that were created at the same point of time. This allows 3D data of the body segment data 7 to be determined, i.e., the positions and orientations of the body segments in space, even if the cameras 5 only capture 2D images B. The 3D data of the body segment data, by the way, could also be determined using a single 3D camera, but multiple cameras are preferred to record images from multiple angles. As shown in the FIGS. 4 to 6, the calculation of the 3D trajectories may also be outsourced from the body segment recognition module 6 to a separate 3D trajectory determination module 6′ in order to make the system more modular. The 3D trajectory determination module 6′ may then be selectively added when needed. However, in the simplest case, it would also be possible to dispense with the 3D data and determine 2D body segment data 7 from a single image B.

Since the cameras 5 may provide images B at regular or irregular time intervals, it is also possible to determine a sequence of body segment data 7. This allows a 3D trajectory of the body segment data 7 to be determined, which is particularly useful for tracking punches or kicks.

It is understood that the body segment recognition module 6 may simultaneously determine body segment data 7 for two or more different athletes 2 in the image B such that these may be provided separately for further processing.

The punch force data determined by means of the punch glove 4 and the body segment data 7 determined by the cameras 5 or the body segment recognition module 6, respectively, subsequently serve as raw data for determining the automated awarding of scores. For this purpose, the punch gloves 4 and the body segment recognition module 6 are connected to an evaluation unit 8. The punch gloves 4 are typically connected to the evaluation unit 8 via a wireless interface, e.g., via Bluetooth or another short-range standard, optionally also via a cellular network. The body segment recognition module 6 may be wired or connected to the evaluation unit 8 via the same wireless communication link as the punch glove 4.

In order for the evaluation unit 8 to perform the automated score awarding, it is additionally connected to a rule set module 9. In the simplest case, the rule set module 9 may also be a memory integrated into the evaluation unit 8 and electronically connected to the evaluation unit 8 in this way. At least one rule set of a predetermined combat sport is stored in the rule set module 9. In FIG. 1, it is indicated that more than one rule set is stored in the rule set module 9. For example, a first rule set may be stored for the combat sport of boxing and a second rule set for the combat sport of karate. The rule set module 9, or in extension the evaluation unit 8, may include an interface, through which there may be chosen which rule set should be used for determining the score awarding. This allows a user of the system 1 to quickly select for which combat sport the athletes 2 are to be evaluated.

The rule sets stored in the rule set module 9 now typically have an assignment of a score for a specific action. For example, if it may be concluded from the body segment data 7 that the first athlete 2 lands a head strike on the second athlete 2 using the right hand (body segment “right forearm” of the first athlete comes into a predetermined proximity of the body segment “head” of the second athlete) and at the same time a predetermined minimum punch force (measured by the punch glove 4) is present, a specific score may then be assigned to this action of the athletes 2. In other words, the rule set provides a score for a hit with a predetermined minimum punch force at a predetermined position of body segment data 7. The evaluation unit 8 thus continuously determines based on the constantly received punch force data and body segment data 7 whether a score may be awarded. In this case, the evaluation unit 8 outputs a corresponding signal via an output 10.

As just described, the evaluation unit 8 only outputs a score if a predetermined punch force is present at a predetermined body position according to the rule set of the predetermined combat sport, i.e., both punch force and body segment data 7 indicate awarding of a score. The presence of only the achieved minimum punch force or only a hit based on the body segment data 7, however, is not sufficient for the evaluation unit 8 to automatically award a score with sufficient accuracy. For such cases, a video verification may be carried out as described further below.

The output 10 mentioned above of the evaluation unit is, in the simplest case, connected to a simple display unit such as an LED lamp to briefly indicate a momentary detection of the score. Typically, the output 10 is connected to a scoring counter system 11, which may be, for example, a display board or also a computer program having extended functions. The scoring counter system 11 may, for example, add up scores output by the evaluation unit 8 and thus display the current score. Upon reaching a predetermined score or a predetermined time, there may also be output an output signal to end the fight.

As shown in FIG. 4, the system 1 from FIG. 1 may also be expanded to include additional functions. In particular, there may be provided a video verification system 12, which is connected to both the evaluation unit 8 and the scoring counter system 11. In certain events, such as a manual request by the athlete 2 or their trainer, or after an ambiguous evaluation by the evaluation unit 8, a specific fight scene may be displayed again on a screen of the video verification system 12. For this purpose, for example, all images B (or videos) captured by the cameras 5 may be stored in a database. If a request to review a fight scene on the video verification system 12 is desired, a sequence of images may be retrieved from the database for the period of time to be reviewed. For example, if a referee determines that a score output by the output unit 8 was not justified, or that the evaluation unit has failed to award a score for a certain action, the referee may enter this information into the video verification system 12 to correct or update, respectively, the score in the scoring counter system 11.

To ensure that the video verification system 12 is not solely dependent on manual intervention, the video verification system 12 may also be connected to the evaluation unit 8. In this case, the evaluation unit 8 may output a review signal to the video verification system 12 if only a predetermined punch force or only a predetermined body position according to the rule set of the predetermined combat sport is present, i.e., the evaluation is ambiguous. As described above, there may then be realized a video verification by a referee, and the score in the scoring counter system 11 may be corrected or updated, respectively.

FIG. 4 also shows that the system 1 may be expanded by a technique recognition module 13. The technique recognition module 13 receives, on the one hand, the body segment data 7 from the body segment recognition module 6 and, on the other hand, acceleration data and/or speed data measured by the punch glove 4. Receiving the punch force data from the punch glove 4 is not necessarily required for this case.

The technique recognition module 13 may comprises in particular two components. Firstly, a punch technique recognition may be performed based on the acceleration and/or speed data of the punch glove 4. Secondly, recognition of the overall movement may be performed, including movements preceding and following the punch, based on the recognition and tracking of the body segment data 7. Both components may be combined to evaluate the validity or scoring, respectively, of a technique in accordance with the regulations of different sports.

In a first example, in karate, there are very strict regulations regarding the quality of technique and posture. Therefore, the sole evaluation of sensor data from the punch glove 4 may be insufficient. For example, hits executed as “hooks” are not considered valid. There may then be used self-learning technique recognition algorithms to improve the evaluation of points or scores.

In a second example, in some sports such as kickboxing, “posture ratings” are not included in the evaluation during technique execution, however, for instance, no point is awarded if the athlete 2 loses balance after executing an otherwise valid technique and touches the ground with body segments other than the feet.

In a third example, in karate, after correctly executed and stably completed scoring technique, it is not permitted to lose focus—for example, to immediately turn away from the opponent in jubilation.

All three of the examples mentioned above for a correct awarding of scores may be considered by the technique recognition module 13. These examples also illustrate clearly the differences between a system 1 with and without the technique recognition module 13. In a system 1 without the technique recognition module 13, the body segment data 7 is used to determine if a hit is present, e.g., by determining if a body segment of an athlete 2 is in a predetermined proximity to a body segment of another athlete 2. The rule set module 9 may simply have the criterion stored for a score based on whether a hit is present due to the minimum punch force and whether a hit is present based on the body segment data 7. If the system 1 comprises a technique recognition module 13, additional criteria may be stored in the rule set, such as “hook—yes/no,” “balance—yes/no,” “turned away from the opponent—yes/no,” etc. The score is only awarded if the correct criteria are met. In an alternative but functionally equivalent implementation, even when the technique recognition module 13 is present, it is also possible that the rule set module 9 only has stored rules for the hit and no criteria regarding the technique scoring. In this case, the technique recognition module 13 itself may contain a rule, for example, that no score should be awarded when recognizing a hook strike such that the technique recognition module 13 may send an invalidation message to the evaluation unit 8.

The technique recognition module 13 may optionally also be directly connected to the video verification system 12 and request a video verification if there is suspicion of a specific action, such as a hook strike, loss of balance, turning away, etc.

FIG. 5 shows that the technique recognition module 13 may further include a machine learning module 14, which can be connected to the evaluation unit 8, the punch glove 4, the body segment recognition module 6 and/or optionally the technique recognition module 13. The purpose of the machine learning module 14 is to internally improve the system components mentioned through machine learning algorithms. In order to realize the machine learning module 14, it may include, for example, an interface for receiving feedback in regard to a score and/or a technique and be configured to adjust an evaluation logic of the evaluation unit 8 and/or optionally the technique recognition module 13.

Typically, the machine learning module 14 is not used “live” during a fight, but rather the data from a fight or multiple fights is recorded and used at a later point of time to optimize one or more of the components. For example, it would be possible to not generate manually the rule set stored in the rule set module but rather to have it generated by the machine learning module 14. For example, measurement data from the combat glove 4 or the cameras 5, respectively, could be recorded from multiple fights. At the same time, the scores manually awarded by the referees are stored as feedback in the machine learning module 14. The machine learning module 14 may then recognize for which combination of punch force data and body segment data 7 a score was awarded and determine rules for the rule set through a learning process. This machine-generated rule set may then be stored in the rule set module 9.

Furthermore, it is possible to individually optimize other components of the system 1. For instance, if an athlete 2 throws a hook and the technique recognition module 13 recognizes the hook with 60% probability/certainty from the data (body segment data 7) of the cameras 5, but with 90% probability/certainty from the measurement data of the punch glove 4, then the technique may also be confirmed for the measurement data of the cameras 5, thus broadening the range of trajectory movement for “hooks” in a specific direction (relative to the athlete's body position). This serves to improve both the overall product and the individual components. Similarly, it should also work with hit recognition using the body segment recognition module 6 (e.g., the hand) and punch force data of the punch glove 2 or various other values.

FIG. 6 shows another embodiment, in which it is possible to process bundled data in a data output module 15 and transmit it to third-party providers 16, such as TV and streaming services, sports betting providers, sports associations, universities, and researchers for creating statistics about athletes 2 or for assessing and further training referees. For these purposes, the evaluation unit 8 is configured to output combat statistics, the technique recognition module 13 to output technique statistics, the punch glove 4 to output technique intensity data, the body segment recognition module 6 to output technique animation and/or kinematic analysis data, and the cameras 5 to output visual data. As depicted in FIG. 6, the output data may be sent to the data output module 15, where it is processed or stored, and may then be accessed by the third-party provider.

1-10. (canceled)

11. A system for automated score awarding in combat sports, comprising:
at least one punching glove for measuring punch force data developing during a punch;
at least one camera for capturing images of at least one athlete;
a body segment recognition module connected to the at least one camera for determining body segment data of the athlete from the images captured by the at least one camera;
a rule set module, in which a rule set of a predetermined combat sport is stored, wherein the rule set provides a score for a punch with a predetermined minimum punch force at a predetermined position of body segment data;
an evaluation unit, which is connected to the punching glove for receiving the punch force data, which is connected to the body segment recognition module for receiving the body segment data, and which is connected to the rule set module for receiving the at least one rule set;
wherein the evaluation unit is configured to output a score fully automatically at an output when both the punch force measured by the punching glove and the body segment data determined by the body segment recognition module result in a score according to the rule set.

12. The system according to claim 11, further comprising a scoring counter system, which is connected to the evaluation unit for receiving the scores output by the evaluation unit, and a video verification system connected to the at least one camera, wherein the video verification system is configured to output the images captured by the at least one camera of a period of time to be verified, and a score of the scoring counter system is updatable or correctable, respectively, after verification on the video verification system.

13. The system according to claim 12, wherein the video verification system is connected to the evaluation unit and wherein the evaluation unit is configured to output a signal for verifying an action of the athlete to the video verification system when only a predetermined punch force or only a predetermined position of body segment data according to the rule set of the predetermined combat sport is present.

14. The system according to claim 11, wherein at least two rule sets of respectively different combat sports are stored in the rule set module and the rule set module has an interface for selecting the rule set used by the evaluation unit.

15. The system according to claim 11, wherein the body segment recognition module is configured to recognize anatomical points on the athlete recognized in the images for determining the body segment data and to connect the body segment data by means of segments.

16. The system according to claim 11, wherein the body segment data determined by the body segment recognition module comprises 3D trajectories of recognized body segments.

17. The system according to claim 11, wherein the punching glove is further configured to record speed data and/or acceleration data, wherein the system further comprises a technique recognition module, which is connected to the punching glove for receiving the speed data and/or acceleration data and which is connected to the body segment recognition module for receiving the body segment data, wherein the technique recognition module is configured to recognize a technique of the athlete from the body segment data in combination with the speed data and/or acceleration data, wherein the evaluation unit is connected to the technique recognition module and takes the recognized technique into account in the score awarding.

18. The system according to claim 17, wherein the recognized technique comprises a punch technique determined by the speed data and/or acceleration data and/or an overall movement technique recognized by the body segment data.

19. The system according to claim 11, further comprising a machine learning module, which is connected to the evaluation unit, the punching glove, the body segment recognition module, and/or the technique recognition module, wherein the machine learning module comprises an interface for receiving feedback regarding a score and/or a technique and is configured to adapt an evaluation logic of the evaluation unit and/or of the technique recognition module or to generate a new rule set for the rule set module.

20. The system according to claim 11, wherein the evaluation unit is configured to output combat statistics, the technique recognition module is configured to output technique statistics, the punching glove is configured to output technique intensity data, the body segment recognition module is configured to output a technique animation and/or kinematic analysis data, and the cameras are configured to output visual data.

21. The system according to claim 11, wherein the at least one camera comprises four cameras.

22. The system according to claim 15, wherein the anatomical points include joint points and wherein the segments includes at least ten, at least fifteen, or at least twenty segments.
